(19) United States
(12) Patent Application Publication
(10) Pub. No.: US 2024/0271002 A1
(43) Pub. Date: Aug. 15, 2024

(54) BIO-BASED CARBON NEGATIVE DURABLE TOPCOATS

(71) Applicant: von Holzhausen, Pacific Palisades, CA (US)

(72) Inventors: Dayong Chen, Los Angeles, CA (US); Vicki von Holzhausen, Pacific Palisades, CA (US); Craig Andrew Machado, Burbank, CA (US)

(21) Appl. No.: 18/412,397

(22) Filed: Jan. 12, 2024

Related U.S. Application Data
(60) Provisional application No. 63/479,951, filed on Jan. 13, 2023.

(51) Int. Cl. C09D 175/12; C09D 7/63; C09D 179/02; D06N 3/00; D06N 3/14

(52) U.S. Cl. CPC C09D 175/12; C09D 7/63; C09D 179/02; D06N 3/0061; D06N 3/009; D06N 3/142; D06N 2203/068; D06N 2205/023; D06N 2205/20

(57) ABSTRACT

This invention discloses an approach of achieving bio-based carbon negative topcoats by developing a plant-based non-isocyanate polyurethane coating. Both bio-based contents and carbon dioxide are used as feeding materials in resin synthesis and formulations, yielding durable topcoats with low environmental footprints.

### 1. CROSS-REFERENCE TO RELATED APPLICATIONS

This application claims the benefit of U.S. Provisional Patent Application No. 63/479,951, filed on Jan. 13, 2023, which is incorporated by reference herein in its entirety.

### 2. BACKGROUND

Polyurethane coatings are broadly used as textile coatings, synthetic leather topcoats, animal leather top-finishes, architectural coatings, aerospace coatings, automotive coatings and industrial maintenance coatings, making them among the most versatile coating types available. While other types of topcoats are being developed (including epoxy types or acrylic types), polyurethane topcoats are generally still preferred thanks to their intrinsic and tunable properties such as flexibility, abrasion and chemical resistance, thermal stability, and good mechanical performance.

Typically, polyurethanes are produced by the polyaddition reaction of petroleum-based polyisocyanates with petroleum-based polyols. In the industrial production process, toxic phosgene gas is used to produce highly reactive isocyanate monomers, which are also toxic to the environment and human health. Such manufactured polyurethanes tend to have a high carbon footprint, and they are not typically degradable after usage, leading to plastic pollution. It is desirable to synthesize isocyanate-free polyurethanes with biobased raw materials to improve the sustainability of and reduce the environmental impact of the raw materials, the manufacturing process, and the end of product life while maintaining the remarkable properties of polyurethane.

### 3. SUMMARY

In one aspect of the invention, a composition includes a combination of one or more cyclic carbonate (CC) monomers based on plant oils or modified plant oils, and biobased polyamines, where the materials are monomers or prepolymers and wherein the composition is in the form of a coating. In one embodiment, the coating is a topcoat for a flexible substrate construct.

A bio-based non-isocyanate poly(hydroxyl urethane) (NIPU) coating for a flexible substrate comprising a combination of polymerized materials selected from: (i) one or more biobased cyclic carbonate (CC) monomers; and (ii) one or more biobased polyamines.

In accordance with any of the embodiments, the coating further comprises one or more plant oils or one or more modified plant oils based cyclic carbonate (CC) monomer formulated by carbon dioxide insertion into one or more epoxidized plant-based oils, one or more epoxidized modified plant-based oils, or one or more biobased-glycidyl ethers/ester-type epoxies.

In accordance with any of the embodiments, the epoxidized plant-based oils comprise epoxidized soybean oil or epoxidized linseed oil.

In accordance with any of the embodiments, the epoxidized modified plant-based oils comprise epoxidized propylene glycol dioleate or epoxidized sucrose soyate.

In accordance with any of the embodiments, the epoxidized modified plant-based oils comprise a first epoxidized oil with a first degree of functionality and a second epoxidized oil with a second degree of functionality higher than the first degree.

In accordance with any of the embodiments, the epoxidized modified plant-based oils have a first monomer having an epoxy degree of functionality of 2, and a second monomer having an epoxy degree of functionality of 8-12.

In accordance with any of the embodiments, the coating further comprises a first cyclic carbonate having a first degree of functionality and a second cyclic carbonate having a second degree of functionality higher than the first degree.

In accordance with any of the embodiments, the biobased polyamines are synthesized by 1) reacting biobased diamine with biobased carboxylic acids; or 2) reacting biobased diamine with biobased carbonate.

In accordance with any of the embodiments, the coating further comprises one or more biobased pigments or catalysts.

In accordance with any of the embodiments, the coating further comprises one or more biobased solvents or additives.

In accordance with any of the embodiments, the coating is formed by the process of: (1) dispersing bio-based NIPU prepolymers in water as a solvent to form a waterborne dispersion; and (2) curing the waterborne dispersion to form the coating.

In accordance with any of the embodiments, the NIPU prepolymers are modified to have carboxylic acid end groups.

In accordance with any of the embodiments, the process further comprises dispersing carbodiimide or epoxy crosslinkers in the waterborne dispersion.

In accordance with any of the embodiments, the process further comprises chain extending amine-terminated NIPU prepolymers with one or more biobased acrylates or chain extending itaconate-terminated NIPU prepolymers with one or more biobased amines.

In one embodiment, a flexible substrate construct includes a coating including a combination of polymerized materials selected from: (i) one or more biobased cyclic carbonate (CC) monomers; and (ii) one or more biobased polyamines.

In accordance with any of the embodiments, the flexible substrate construct is bonded to a plant-based backing fabric on top of the coating thereby yielding a carbon negative bio-based leather alternative having specific mass ratio carbon dioxide incorporation.

In accordance with any of the embodiments, the coating is applied as a textile coating or a flexible substrate coating.

In one embodiment, a method of preparing a formulation comprising a bio-based non-isocyanate poly(hydroxyl urethane) (NIPU) coating for a flexible substrate comprising one or a combination of polymerized materials selected from: (i) one or more biobased cyclic carbonate (CC) monomers; and (ii) one or more biobased polyamines.

In accordance with any of the embodiments, the method further comprises synthesizing one or more plant oils or one or more modified plant oils based cyclic carbonate (CC) monomers as the biobased cyclic carbonate (CC) monomers by carbon dioxide insertion into one or more epoxidized plant-based oils or one or more epoxidized modified plant-based oils, or one or more biobased-glycidyl ethers/ester-type epoxies.

In accordance with any of the embodiments, the epoxidized plant-based oils comprise epoxidized soybean oils or epoxidized linseed oils.

In accordance with any of the embodiments, the epoxidized modified plant-based oils comprise epoxidized propylene glycol dioleate or epoxidized sucrose soyate.

In accordance with any of the embodiments, the method further comprises converting one or more epoxidized modified plant-based oils including a first oil to achieve cyclic carbonates with a first degree of functionality, and converting a second oil to achieve cyclic carbonates with a second degree of functionality higher than the first degree.

In accordance with any of the embodiments, the epoxidized modified plant-based oils have a first monomer having an epoxy degree of functionality of 2, and a second monomer having an epoxy degree of functionality of 8-12.

In accordance with any of the embodiments, the method further comprises using first cyclic carbonates with a first degree of functionality and second cyclic carbonates with a second degree of functionality higher than the first degree.

In accordance with any of the embodiments, the method further comprises synthesizing the biobased polyamines by 1) reacting biobased diamine with biobased carboxylic acids; and 2) reacting biobased diamine with biobased carbonate.

In accordance with any of the embodiments, the method further comprises formulating the bio-based NIPU coating with biobased pigments or catalysts.

In accordance with any of the embodiments, the method further comprises formulating the bio-based NIPU coating with biobased solvents or additives.

In accordance with any of the embodiments, the method further comprises: dispersing bio-based NIPU prepolymers in water as a solvent to form a waterborne dispersion; and curing the waterborne dispersion to form the coating.

In accordance with any of the embodiments, the NIPU prepolymers are modified to have carboxylic acid end groups.

In accordance with any of the embodiments, the method further comprises dispersing carbodiimide or epoxy crosslinkers in the waterborne dispersion.

In accordance with any of the embodiments, the method further comprises chain extending amine-terminated NIPU prepolymers with one or more biobased acrylates or chain extending itaconate-terminated NIPU prepolymers with one or more biobased amines.

In accordance with any of the embodiments, the method further comprises constructing a leather alternative by bonding a plant-based backing fabric on top of an oven-cured biobased NIPU coating thereby yielding a carbon negative bio-based leather alternative having specific mass ratio carbon dioxide incorporation.

In accordance with any of the embodiments, the method further comprises applying the coating in an application selected from a group consisting of: a textile coating and an animal leather top-finish.

In accordance with any of the embodiments, the method further comprises applying the coating in an application selected from a group consisting of: a textile coating, an animal leather top-finish, a wood coating, a floor coating, a paper coating, an architectural coating, an aerospace coating, an automotive coating, and an industrial maintenance coating.

In accordance with any of the embodiments, the method further comprises using a spray procedure to deposit the coating.

In accordance with any of the embodiments, the method further comprises using one or more solvents or additives in the coating.

### 4. BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present invention will become better understood with regard to the following description, and accompanying drawings, where:

FIG. 1 (left) illustrates a sample of NIPU made from linseed oil carbonate cured with Croda Priamine 1074 and (right) piece of fabric coated with a fully formulated NIPU topcoat, in accordance with one or more embodiments.

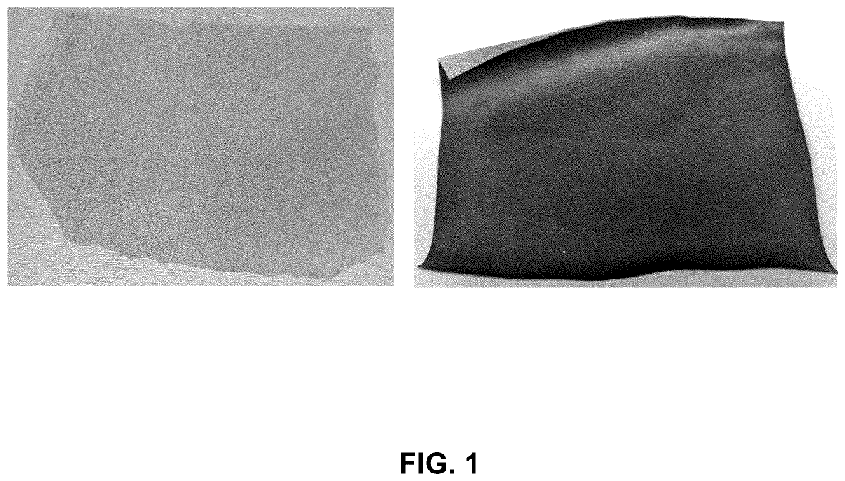

### 5. DETAILED DESCRIPTION

### 5.1. Definitions

The term “bio-based” or “biobased” is used throughout to refer to materials or chemicals that are derived from renewable biomass or bio-fermented products instead of petroleum.

The term “degree of functionality” refers to the number of functional groups or bonding sites in a monomer or molecule for bonding.

### 5.2. Coatings

In one embodiment, coatings comprise a combination of polymerized materials selected from one or more cyclic carbonate (CC) monomers based on plant oils or modified plant oils; and biobased polyamines.

Described here is a synthesis procedure of cyclic carbonate (CC) monomers based on plant oils or modified plant oils, a synthesis procedure of biobased polyamines, and a formulation and processing scheme or method of preparing a formulation of biobased NIPU carbon negative supple and durable topcoats by formulating with biobased cyclic carbonate (CC) monomers and biobased polyamines.

An additional aspect of the present disclosure is the provision of a composition comprising one or more biobased cyclic carbonate (CC) monomers and one or more biobased polyamines. In one embodiment, the composition is a coating or topcoat. In a further embodiment, the coating or topcoat is designed to be supple and durable.

Out of several reported synthesis pathways of isocyanate-free polyurethanes, biobased non-isocyanate poly(hydroxyl urethane) (NIPU) with the use of cyclic carbonate (CC) monomers crosslinked by primary amino groups of aliphatic or cycloaliphatic polyamines has gained the most academic and industrial attention for being the most desirable and low-cost approach.

While 100% biobased NIPUs have become technically possible, the synthesis of cyclic carbonate (CC) monomers through chemical insertion of carbon dioxide into epoxy resins can further push the process into carbon negative category, thereby producing durable topcoats with even lower carbon footprints. A focused effort of biobased raw materials is to use plant oils or modified plant oils as the starting materials, through epoxidation of C═C double bonds, and insertion of carbon dioxide into the formed epoxy rings to create cyclic carbonate (CC) monomers. Biobased NIPU topcoats with supple and durable mechanical properties mimicking the haptics and mechanical properties of animal skin leathers provide an advantage over conventional designs.

As stated above, in certain embodiments, the composition is in the form of a topcoat. In one embodiment, the topcoat described herein is a coating that is applied to flexible substrates, such as include woven/knitted/non-woven fabric, cloth, paper sheet, plastic film, metal foil/mesh, animal hide leather, wood veneer, mushroom-based textile, or other types of backing textiles to protect the textile from abrasions and wear. For example, the topcoat or coating may be used with leather alternative products, such as a handbag, purse, tote, backpack or other bag or carrying item made of a leather alternative. In one embodiment, the topcoat gives the material a waterproof protective layer and is a clear coating. In one embodiment, the topcoat described herein may have a thickness of 25-450 μm.

In alternative embodiments, while the plant-based coatings are primarily engineered for leather alternative produce topcoats, they are readily reformulated for other topcoat applications such as automotive exterior coatings, furniture coatings, aerospace coatings, roof coatings, architecture coatings by masters of the art.

### 5.3. Flexible Substrate Construct

In one embodiment, a flexible substrate construct is formed by applying the coating described herein to flexible substrates. In one instance, a flexible substrate includes woven/knitted/non-woven fabric, cloth, paper sheet, plastic film, metal foil/mesh, animal hide leather, wood vencer, mushroom-based textile, or other types of backing textiles to protect the material from abrasion and wear. In one embodiment, the backing textile for synthetic leather construction includes plant-based fabrics or recycled-plastic based fabrics. In some embodiments, plant-based fabrics include but are not limited to organic cotton, linen, seaweed, and/or bamboo fabrics. In some embodiments, the backing textile also includes certain blends with fibers derived from agriculture wastes. In some embodiments, recycled-plastic based fabrics include recycled (polyethylene terephthalate) (PET). Depending on the application, the fabric is woven, knitted or non-woven. In particular embodiments, the leather alternative construct is formulated with the cyclic carbonate (CC) monomers and biobased polyamines described in section 5.4. In a particular embodiment, the flexible substrate construct is formed by applying a topcoat of Formulations 1 to 8 on a plant-based backing textile.

### 5.4. Prepolymer Materials

### 5.4.1. Biobased Cyclic Carbonate (CC) Monomers

One ingredient in biobased non-isocyanate poly(hydroxyl urethane) (NIPU) is biobased cyclic carbonate (CC) monomers. While it is possible to use a mass balance approach to produce cyclic carbonate (CC) monomers with partial or even 100% biobased carbon contents, in one embodiment, C═C double bonds are converted in plant-based oils or modified plant oils into epoxy rings, followed by subsequent insertion of carbon dioxide to produce cyclic carbonate (CC) monomers for its readily available raw materials and processing simplicity.

Plant-based oils are a mixture of triglycerides. As listed in Table 1, depending on the type of the plant-based oil, they have different ratios among these three different glycerides; saturated; monounsaturated; and polyunsaturated. While monounsaturated and polyunsaturated glycerides provide reaction sites for chemical modification and crosslinking, saturated ones will not be able to react. These saturated chains will exist as dangling side-chains in the cured networks, thereby weakening the cured topcoats. To achieve durable topcoats, it is desirable to use plant-based oils that are low in saturated glycerides.

In certain embodiments, only plant-based oils with less than 20% saturated glycerides will be used. In certain other embodiments, only plant-based oils with less than 10% saturated glycerides are used. In further embodiments, only plant-based oils with other percentages of saturated glycerides are used, including a range from 6 to 9%.

TABLE 1
Plant-based oils and their composition

| Type | Saturated | Monounsaturated | Polyunsaturated |
|---|---|---|---|
| Canola oil | 7.4 | 63.3 | 28.1 |
| Corn oil | 12.9 | 27.6 | 54.7 |
| Linseed oil | 9 | 18.4 | 67.8 |
| Grape seed oil | 10.5 | 14.3 | 74.7 |
| Hemp seed oil | 7 | 9 | 82 |
| Olive oil | 13.8 | 73 | 10.5 |
| Peanut oil | 16.2 | 57.1 | 19.9 |
| Sesame oil | 14.2 | 39.7 | 41.7 |
| Soybean oil | 15.6 | 22.8 | 57.7 |
| Walnut oil | 9.1 | 22.8 | 63.3 |
| Sunflower oil | 8.99 | 63.4 | 20.7 |

While it is undesirable to incorporate plant-based oils with high saturated glycerides in the resin synthesis for the subsequent coating formulation, epoxidized plant-based oils tend to have an averaged degree of epoxy functionality of 4-6. The chemical properties of two examples: epoxidized soybean oil (e.g. Cargill Vikoflex® 7170) and epoxidized linseed oil (e.g. Vikoflex® 7190 or ACS Technical Products EPOXOL® 9-5) are presented in Tables 2-4.

### Formula 1. Generalized Structure of Epoxidized Vegetable Oil.

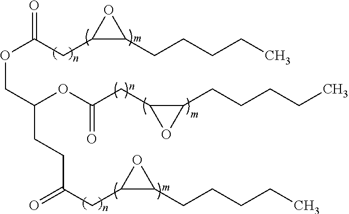

Assuming high conversion (>95%) of epoxides into cyclic carbonates, cyclic carbonates based on plant-based oils tend to have high degree of carbonate functionality. Only using cyclic carbonates with high degree of functionality can yield highly crosslinked polymer network, resulting in brittle coatings. To achieve durable topcoats with high elongation to break strain as in supple animal leathers, it is desirable to also include biobased cyclic carbonates with lower degree of functionality into the topcoat formula. Such cyclic carbonates can be obtained from converting epoxidized modified plant-based oil with low degree of functionality. One example is epoxidized propylene glycol dioleate (commercially available Cargill Vikoflex® 5075).

On the other hand, to achieve topcoats with high crosslinking density, high modulus, and good scratch resistance, it is also beneficial to include certain high degree of functionality cyclic carbonates. One such example is to convert epoxidized sucrose soyate. Sucrose soyate is modified from soybean oil, and is produced commercially by, for example, Proctor and Gamble under the trade name of SEFOSE. A simple oxidation process can convert sucrose soyate into epoxidized sucrose soyate with a degree of functionality in the range of 8-12. The chemical properties of both epoxidized propylene glycol dioleate and epoxidized sucrose soyate are also presented in Table 2 and 5.

TABLE 2
Epoxidized plant-based oils and epoxidized
modified plant-based oils.

| | Epoxy oxygen | Average degree of |
|---|---|---|
| Chemical | content | functionality |
| Epoxidized soybean oil | 6.9% | ~4 |
| Epoxidized linseed oil | 9.2% | ~6 |
| Epoxidized propylene | 4.7% | 2 |
| glycol dioleate | | |
| Epoxidized Sucrose soyate | 6.4% | 8-12 |

TABLE 3
Physical properties of Vikoflex ® 7170.
TYPICAL PHYSICAL PROPERTIES

| | |
|---|---|
| [symbol] Oxygen | [symbol] |
| [symbol] | [symbol] |
| Color - APHA | [symbol] |
| [symbol] | [symbol] |
| [symbol] @ 25° C. | [symbol] |
| [symbol] | [symbol] |
| [symbol] Weight | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

TABLE 4
Physical properties of Vikoflex ® 7190.
TYPICAL PHYSICAL PROPERTIES

| [symbol] Oxygen | 9.0 % [symbol] | |
|---|---|---|
| Acid Value | 0.5 | Max |
| Specific Gravity 25/25° C. | 1.03 | |
| Refractive Index @ 25° C. | [symbol] | |
| Color [symbol] APHA | 225 | Max |
| [symbol] Point | 343° | C. |
| [symbol] Per Gallon @ 25° C. | [symbol] | |
| Odor | Very low | |
| Viscosity @ 25° C. | [symbol] | Min |
| Iodine | 3.5 | Max |

[symbol]

indicates data missing or illegible when filed

TABLE 5
Physical properties of Vikoflex ® 5075.
TYPICAL PHYSICAL PROPERTIES

| [symbol] Oxygen | [symbol] | |
|---|---|---|
| Acid Value | 1.0 | Max |
| [symbol] @ 25° C. | 1.2 | |
| Color - APHA | 175 | Max |
| Flash Point | <500° | F. |
| Freeze Point | 32° | F. |

[symbol]

indicates data missing or illegible when filed

In addition to epoxidized plant oils, other biobased epoxy compounds can also be used as the basis for CC monomers. For example, Epotec® RD 135 G is a diglycidyl ether of isosorbide. In one embodiment, this epoxide is converted into a difunctional carbonate monomer. This difunctional monomer has a few differences that can be beneficial when compared to carbonated Vikoflex® 5075. First, the carbonate moieties are not sterically hindered by the long alkyl chains present in Vikoflex® 5075: this improved accessibility should increase the reactivity of the carbonates compared to Vikoflex® 5075. Second, the carbonate moieties are closer together and connected by a bicyclic backbone. This geometry would result in urethane groups in close proximity for strong hydrogen bonding. The reduced polymer chain rotation from the bicyclic structure would also be advantageous for creating a “hard block” in a polyurethane elastomer. Third, this monomer is free of ester groups. When reacting amines with carbonate monomers at high temperature (>120)° ° C., the amine groups can also react with ester linkages instead of the intended carbonate moieties. Thus, isosorbide carbonate monomer is better suited for high-temperature curing than is Vikoflex® 5075. However, the dense hydrogen bonding and restricted chain rotation afforded by isosorbide carbonate may not always be desired over the flexibility of carbonated Vikoflex® 5075, so having both options allows for a variety of polymer properties.

Formula 2 illustrates structures for a generalized difunctional carbonate monomer (top), for carbonated isosorbide (bottom left) and Vikoflex 5075 (bottom right), in accordance with one or more embodiments.

### Formula 2. Structures for Generalized Difunctional Carbonate Monomers, Carbonated Isosorbide, and Carbonated Vikoflex 5075.

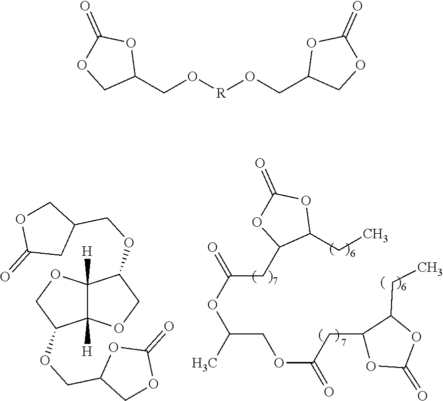

In another embodiment, other difunctional carbonate monomers may be used. Just as the differences between carbonated Vikoflex® 5075 and isosorbide carbonate lead to differences in the properties of the resulting NIPU, different difunctional carbonate monomers may also impart unique properties to the final NIPU.

To convert epoxidized plant-based oils and epoxidized modified plant-based oils into cyclic carbonates through carbon dioxide insertion, a stirred pressure reactor may be used, such as PAR-4530 from Parr Instrument Company.

In one embodiment, the method includes charging 1000 grams epoxidized linseed oil Vikoflex® 7190 and 35 grams tetrabutylammonium bromide as the catalyst in the reactor. The reactor is then charged with pressurized carbon dioxide. The reactor is heated to 140° C. and the pressure maintained at 3 MPa. The reaction is then allowed to proceed for 10 hours before cooling down, affording a nearly 100% conversion of epoxy moieties into cyclic carbonate (linseed oil carbonate).

In another embodiment, the method includes charging 1000 grams Vikoflex® 5075 epoxidized propylene glycol dioleate and 20 grams tetrabutylammonium bromide as the catalyst in the reactor. The other reaction conditions were maintained the same as the example above, yielding biobased carbonate (5075 carbonate) with nearly 100% conversion.

It is desirable to remove tetrabutylammonium bromide catalyst from the products before proceeding to coating formulation. A simple wash of the products with water and using a separation funnel to separate the oil phase and the water phase was found to remove approximately 95% of the catalyst. Such removed catalyst can easily be recycled for future use.

TABLE 6
Carbon dioxide incorporation in synthesized biobased carbonates.

| | Carbon dioxide |
|---|---|
| Chemicals | incorporation mass % |
| Linseed oil carbonate | 20.0 |
| 5075 carbonate | 11.4 |
| Isosorbide carbonate | 22.8 |

### 5.4.2. Biobased Glycidyl Ethers

Using biobased epichlorohydrin may allow us to synthesize a variety of custom epoxide-functionalized monomers/polymers. Whereas the above-mentioned epoxidation reactions are suitable for transforming alkenes into epoxides, epichlorohydrin can react with alcohols to create terminal epoxides (referred to as glycidyl ethers). These glycidyl ethers may be used directly for curing with amines/carboxylic acids or they may be converted into carbonates through fixation of CO₂.

In one embodiment, a polyol such as poly(trimethylene ether glycol) (PO3G) would be reacted with two equivalents of epichlorohydrin to produce a polymer with two glycidyl ether end groups. As mentioned above, this glycidyl ether could either be cured with amines or carboxylic acids, or it could be reacted with CO2 to produce a difunctional carbonate monomer. One benefit of this approach is that epoxide-terminated and carbonate-terminated polymers can be made from many commercially available polyol (or small molecule alcohol). By installing carbonate moieties on the termini of polymer chains, the resultant urethane linkages that form when cured can be spaced farther apart than is possible with small-molecule di-carbonates. Thus, both small-molecule and polymeric alcohols can be used to make carbonate monomers; by mixing and matching carbonate monomers of various equivalent weights and functionalities, cured films with a variety of hydrogen bonding densities can be achieved.

Formula 3 illustrates (top) a reaction with a generalized bio-based polyether with epichlorohydrin to form polyether carbonate, and (bottom) reaction of PO3G with epichlorohydrin to form PO3G diglycidyl ether followed by carbonation of PO3G diglycidyl ether to form PO3G carbonate. In one embodiment, n is an integer greater than 1, greater than 2, greater than 3, greater than 4, greater than 5, greater than 6, greater than 7, greater than 8, greater than 9, greater than 10, greater than 11, greater than 12.
Formula 3. Reaction with a Generalized Bio-Based Polyether with Epichlorohydrin to Form Polyether Carbonate (Top), Reaction of PO3G with Epichlorohydrin Followed by Carbonation (Bottom).

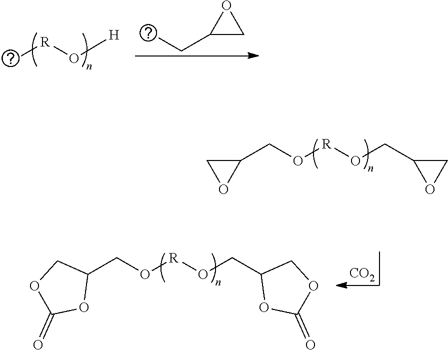

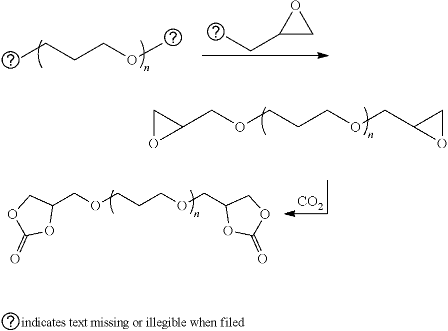

### 5.4.3. Biobased Polyamines

In one embodiment, another ingredient in formulating biobased non-isocyanate poly(hydroxyl urethane) (NIPU) is biobased polyamine. Biobased polyamines can come from three different routes: 1) chemically modifying natural occurring molecules; 2) chemical synthesis based on a mass balance approach; or 3) using a bio-fermentation process. Biobased amine monomers include diaminoisosorbide, isophoronediamine (Vestamin® eCO IPD), lysine, furanyl amines, 1,5-diaminopentane, hexamethylenediamine, and dimer fatty acid diamine (Croda Priamine® 1074).

In certain embodiments, the method includes using these diamine monomers directly in the topcoat formulations. In certain other embodiments, the method includes synthesis of some polyamine prepolymers for topcoat formulations. These polyamine polymers can be synthesized by 1) reacting biobased diamine with biobased carboxylic acids; and 2) reacting biobased diamine with biobased carbonate. Five polyamine prepolymer synthesis examples are shown below:

TABLE 7
Synthesis of polyamide polyamine 1.

| Chemicals | Loading ratio by amount |
|---|---|
| Hexmethylenediamine | 3 |
| Sebacic acid | 2 |

TABLE 8
Synthesis of polyamide polyamine 2.

| Chemicals | Loading ratio by amount |
|---|---|
| Hexmethylenediamine | 1 |
| Croda Priamine 1074 | 1 |
| Sebacic acid | 1 |

TABLE 9
Synthesis of poly (hydroxyl urethane) polyamine 1.

| Chemicals | Loading ratio by amount |
|---|---|
| Hexmethylenediamine | 3 |
| 5075 carbonate | 2 |

TABLE 10
Synthesis of poly (hydroxyl urethane) polyamine 2 (PHU2).

| Chemicals | Loading ratio by amount |
|---|---|
| Priamine 1074 | 3 |
| Epotec ® RD 135 G Carbonate | 2 |

### Formula 4. Synthesis of PHU2.

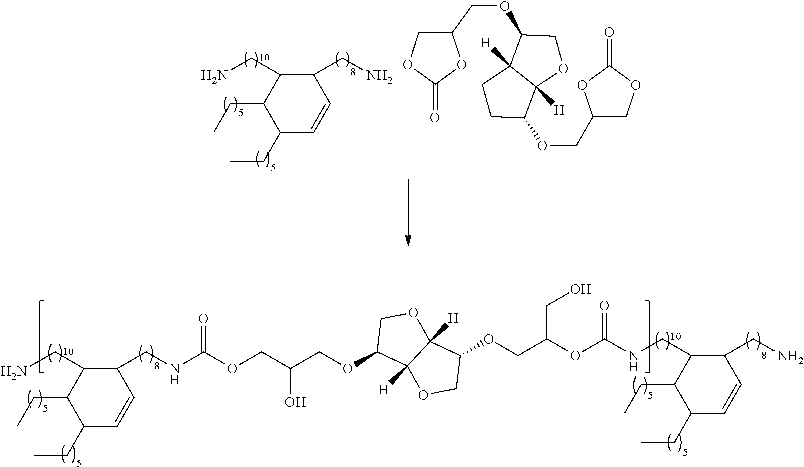

TABLE 11
Synthesis of poly (hydroxyl urethane) polyamine 3.

| Chemicals | Loading ratio by amount |
|---|---|
| Priamine 1074 | 5 |
| Epotec ® RD 135 G Carbonate | 3.33 |
| DENACOL ® GEX-313 Carbonate | 0.67 |

### 5.4.4. Acid-Terminated NIPU Prepolymers

In certain embodiments, NIPU prepolymers will be modified so as to have carboxylic acids on the end groups to allow curing with carbodiimides (vide infra in “water-based curing”). As such, the amine termini of NIPU prepolymers will be reacted with succinic anhydride or itaconic anhydride to generate an amide linkage and free carboxylic acid end group. Anhydrides will be used instead of difunctional carboxylic acids because the pendent hydroxyl groups on the NIPU could also react with the acids and result in crosslinking. By using an anhydride, lower temperatures can be used, and the amines of the NIPU will be able to react before the hydroxyl groups can.

Two examples of acid-terminated NIPU prepolymers are shown below:

TABLE 12
Synthesis of succinic-acid-terminated PHU2 (SucPHU2).

| Chemicals | Loading ratio by amount |
|---|---|
| PHU2 | 1 |
| Succinic anhydride | 1.05 |

TABLE 13
Synthesis of itaconic-acid-terminated PHU2 (ItPHU2).

| Chemicals | Loading ratio by amount |
|---|---|
| PHU2 | 1 |
| Itaconic anhydride | 1.05 |

### 5.5. Solvent Systems

Solvent systems are used to coat or cast the composition for the coating described herein. In some embodiments, spray coating or dip coating processes are used. In some embodiments, changing to different solvent systems will be preferred for different coating processes.

### 5.6. Water-Based Curing

Water-based NIPU dispersions will be used for certain embodiments. In some embodiments, the method includes protonating the amine groups on the NIPU polymer chains with acid to induce a positive charge on the polymer to allow the hydrophobic polymer to be dispersed in water, thus reducing the viscosity without the need for organic solvents. In such cases, crosslinkers containing carbonate and/or acrylate and/or epoxy functionalities would be co-dispersed, and (upon drying and subsequent heating), would cure into a solid film.

In other embodiments, anionic dispersions would be made. In such cases, the amine end groups of the polymer chains would be converted to carboxylic acids and subsequently neutralized with base. The ionized polymer would then be dispersed in water and could be co-dispersed with carbodiimide and/or epoxy crosslinkers. Upon drying and subsequent heating, the polymer would crosslink into a solid film.

The benefit of using crosslinkers such as acrylates, epoxies, and/or carbodiimides (herein referred to as “hybrid cure”) is the ability to combine the exceptional properties of NIPU polymers with the fast cure time of other chemistries. For example, acrylate and epoxy crosslinkers can react with amines and carbodiimides can react with carboxylic acids within minutes at moderate (≤120° C.) temperatures or at room temperature for longer periods of time. Conversely, crosslinking with carbonate crosslinkers requires higher temperatures and/or longer curing times.

### 5.7. In Situ Chain Extension

In addition to casting films from aqueous dispersions, such dispersions may also be useful for creating high molecular weight NIPU polymers. Although high molecular weight polymer can be achieved without first dispersing in water, the viscosity of such polymers would be impractically high and present problems both during the synthesis and subsequent dispersion. In one embodiment, a difunctional epoxy monomer (such as Epotec® RD 135 G) would be added to a dispersion of amine-terminated NIPU. Amines and epoxides can react at room temperature, so the low molecular weight NIPU polymers can be extended into high molecular weight polymers in the aqueous dispersion at low viscosity.

In another embodiment, a difunctional acrylate monomer would be used in lieu of the epoxy monomer. In this case, the amine terminals of the NIPU would react in an aza-Michael addition mechanism. The chain extension would function in the same manner as with the amine-epoxy extension. However, one additional benefit that can arise from the aza-Michael addition mechanism is that acrylic acid can be added to turn the cationic dispersion into an anionic dispersion if carbodiimide curing is desired. Thus, different curing mechanisms are available depending on the presence/absence of the acrylic acid.

Formula 5. In Situ Chain Extension of PHU2 Using Difunctional Acrylate and Optional Capping with Acrylic Acid.

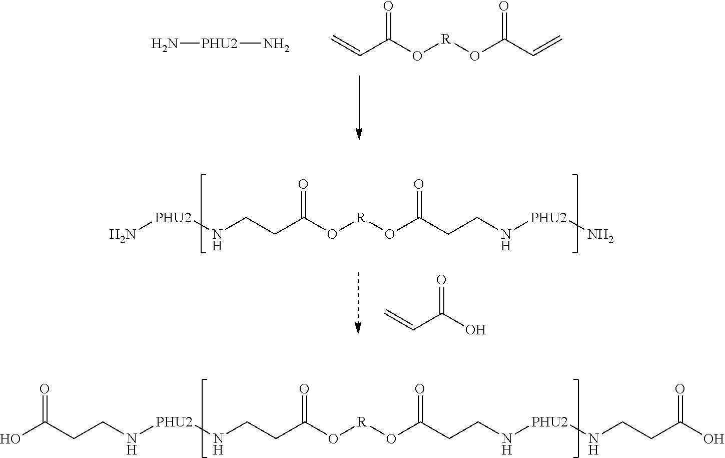

In another embodiment, itaconate-terminated polymers (such as, but not limited to ItPHU2) could be chain extended with a diamine. This approach is similar to the above-mentioned method but with the functional groups swapped. One major difference between the two methods, however, is the number of carboxylic acid groups present per molecule after chain extension. Above, acid groups would only be present on the polymer chain ends (if reacted with acrylic acid). In this embodiment, carboxylic acids would be pendent within the polymer backbone. This higher number of carboxylic acids may be beneficial in maintaining a stable dispersion depending on the molecular weight and hydrophobicity of the polymer backbone. The number of carboxylic acids present on the polymer chain would also affect the curing kinetics and crosslink density when curing with carbodiimides. Finally, this embodiment is applicable to both amine-terminated and alcohol-terminated polymers. Formula 6 depicts the chain extension of ItPHU2, which was made from an amine-terminated PHU reacted with itaconic anhydride. But a polyol could similarly be reacted with itaconic anhydride to permit this same chain extension procedure.

Formula 6. Chain extension of ItPHU2 with diamine.

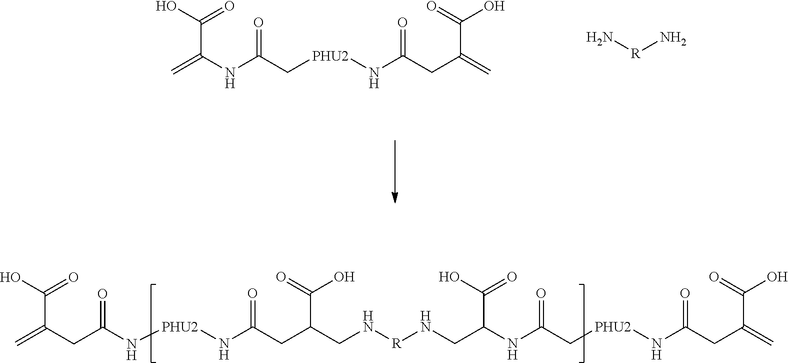

A variety of methods have been presented for the chain extension of polymers in aqueous dispersion. Amine-terminated polymers can be extended with either difunctional epoxy or acrylate monomers whereas itaconate-terminated polymers can be extended with diamine monomers. Thus, in situ chain extension of polymers in aqueous dispersion can be applied to polymers with different chain ends. Additionally, after chain extension, a variety of curing methods are available to create the final film. This in situ chain extension will enable a higher molecular weight between crosslinks while obviating the need to deal with the impractical viscosities of high molecular weight polymers. The resultant films will have higher elongation than those made without the chain extension.

### 6. EXAMPLES

### 6.1. Summary of the Examples

Example leather-like topcoats are formulated with as high as 96-100% plant-based carbon in the formula by using both cyclic carbonate monomers and biobased polyamines in the formula.

### 6.2. General Protocol

In an example procedure of creating a plant-based supple and durable topcoats, bio-carbonates, biobased polyamines, catalysts, pigments, and other additives were mixed together by hand. Solvents were added, in this example, to adjust the viscosity of the liquid formula, and stirred until a homogenous solution was obtained. This mixed formula was then left in a sealed container for certain amount of time to allow air bubbles to escape. Then the mixture was cast on a release paper using a Mathis roller coating device. A 250-400 μm layer was cast and placed on a hot plate at 50° C. for certain amount of time, typically less than one hour to allow solvent to evaporate. This layer was placed in a 160° C. oven for 5 minutes to cure. An additional 20-50 μm layer of the same mixed formula or different formula was then cast on top of the initial layer. Such coated bi-layer was placed in the 160° C. oven for another 1-2 minutes. A weaved or knitted fabric was then laminated on top of the adhesive layer. Following the lamination, the construction was placed in the 160° C. oven for another 2-5 minutes. After removal from the oven, the resin layers and fabric were all found to be well-bonded with minimal adhesive wicking through the backing fabric. The composite was separated from the release paper.

Although the above description only describes a process of producing leather alternatives using formulated bio-based NIPU topcoats, such formulated bio-based NIPU topcoats can be applied to various other flexible substrates in other applications. These applications include, but are not limited to, textile coatings, animal leather top-finishes, wood coatings, floor coatings, paper coatings, architectural coatings, aerospace coatings, automotive coatings, and industrial maintenance coatings. In these applications, a different application procedure, such as spray coating, may be favored. The coating formulas may need to be adjusted accordingly to incorporate certain solvents and/or additives.

### 6.3. Example Topcoat Formulations

Some example topcoat formulations are given in the below:

### 6.3.1. Formulation 1

Formulation 1 illustrates a topcoat formula in which linseed oil carbonate Croda Priamine 1074 is mixed with a ratio of 1.0:0.95.

In one embodiment, the mixing ratio (molar ratio unless specified otherwise) may be within the range of 0.9-1.1:0.85-1.05. The carbon dioxide incorporation mass % may be within the range of 8.1-9.9%.

A free-standing film (not coated on any fabric) of this NIPU exhibited an elongation of 150%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 1.0 |
| Croda Priamine 1074 | 274 | N/A | 0.95 |
| Celluforce cellulose | filler | N/A | 3% (by weight) |
| nano crystals | | | |
| Triazabicyclodecane | catalyst | N/A | 1% (by weight) |

Carbon dioxide incorporation mass %: 9.0, where carbon dioxide incorporation mass % is computed after accounting for priamine and additives.

### 6.3.2. Formulation 2

Formulation 2 illustrates a topcoat formula in which linseed oil carbonate to 5075 carbonate to Croda Priamine 1074 is mixed with a ratio of 0.2:1:1.15.

In one embodiment, the mixing ratio may be within the range of 0.18-0.22:0.9-1.1:1.04-1.26. The carbon dioxide incorporation mass % may be within the range of 6.0-7.4%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 0.2 |
| 5075 carbonate | 384 | 11.4 | 1 |
| Croda Priamine 1074 | 274 | N/A | 1.15 |
| CAB-O-SIL TC-610 | silica rheology | N/A | 3% (by weight) |
| | modifier | | |
| XPB772 | plant-based | N/A | 2% (by weight) |
| | carbon black | | |
| Triazabicyclodecane | catalyst | N/A | 1% (by weight) |

Carbon dioxide incorporation mass %: 6.7.

### 6.3.3. Formulation 3

Formulation 3 illustrates a topcoat formula in which linseed oil carbonate to 5075 carbonate to polyamide polyamine 1 is mixed with a ratio of 0.2:1:1.15.

In one embodiment, the mixing ratio may be within the range of 0.18-0.22:0.90-1.10:1.04-1.26. The carbon dioxide incorporation mass % may be within the range of 5.2-6.4%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 0.2 |
| 5075 carbonate | 384 | 11.4 | 1 |
| polyamide polyamine | 376 | N/A | 1.15 |
| 1 | | | |
| CAB-O-SIL TC-610 | silica rheology | N/A | 3% (by weight) |
| | modifier | | |
| XPB772 | plant-based | N/A | 2% (by weight) |
| | carbon black | | |
| Triazabicyclodecane | catalyst | N/A | 1% (by weight) |

Carbon dioxide incorporation mass %: 5.8.

### 6.3.4. Formulation 4

Formulation 4 illustrates a topcoat formula in which linseed oil carbonate to 5075 carbonate to polyamide polyamine 2 is mixed with a ratio of 0.2:1:1.15.

In one embodiment, the mixing ratio may be within the range of 0.18-0.22:0.90-1.10:1.04-1.26. The carbon dioxide incorporation mass % may be within the range of 4.9-5.9%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 0.2 |
| 5075 carbonate | 384 | 11.4 | 1 |
| polyamide polyamine | 433 | N/A | 1.15 |
| 2 | | | |
| CAB-O-SIL TC-610 | silica rheology | N/A | 3% (by weight) |
| | modifier | | |
| XPB772 | plant-based | N/A | 2% (by weight) |
| | carbon black | | |
| Triazabicyclodecane | catalyst | N/A | 1% (by weight) |

Carbon dioxide incorporation mass %: 5.4.

### 6.3.5. Formulation 5

Formulation 5 illustrates a topcoat formula in which linseed oil carbonate to 5075 carbonate to poly (hydroxyl urethane) polyamine 1 is mixed with a ratio of 0.2:1:1.15.

In one embodiment, the mixing ratio may be within the range of 0.18-0.22:0.90-1.10:1.04-1.26. The carbon dioxide incorporation mass % may be within the range of 8.0-9.8%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 0.2 |
| 5075 carbonate | 384 | 11.4 | 1 |
| poly (hydroxyl | 942 | 8.4 | 1.15 |
| urethane) | | | |
| polyamine 1 | | | |
| CAB-O-SIL TC-610 | silica rheology | N/A | 3% (by weight) |
| | modifier | | |
| XPB772 | plant-based | N/A | 2% (by weight) |
| | carbon black | | |
| Triazabicyclodecane | catalyst | N/A | 1% (by weight) |

Carbon dioxide incorporation mass %: 8.9.

### 6.3.6. Formulation 6

Formulation 6 illustrates a topcoat formula in which linseed oil carbonate to Denacol GEX-313 carbonate to Priamine 1074 is mixed with a ratio of 0.5:0.5:0.95.

In one embodiment, the mixing ratio may be within the range of 0.45-0.55:0.45-0.55:0.85-1.15. The carbon dioxide incorporation mass % may be within the range of 8.6-10.6%.

| | | Carbon dioxide | |
|---|---|---|---|
| | Equivalent | incorporation | Mixing |
| Tradename/Name | weight | mass % | amount ratio |
| Linseed oil carbonate | 218 | 20.0 | 0.5 |
| Denacol GEX-313 | 202 | 23.7 | 0.5 |
| Carbonate | | | |
| Croda Priamine 1074 | 274 | N/A | 0.95 |
| CAB-O-SIL TC-610 | silica rheology | N/A | 3% (by weight) |
| | modifier | | |
| XPB772 | plant-based | N/A | 2% (by weight) |
| | carbon black | | |
| Triazabicyclodecane | catalyst | N/A | 1% (by weight) |

Carbon dioxide incorporation mass %: 9.6.

### 6.3.7. Formulation 7

Formulation 7 illustrates a topcoat formula in which SucPHU2 to Desmodur 2802 (carbodiimide crosslinker) is mixed with a ratio of 1.0:1.2.

In one embodiment, the mixing ratio may be within the range of 0.90-1.1:1.1-1.3. The carbon dioxide incorporation mass % may be within the range of 4.0-4.8%.

| | | Carbon dioxide | |
|---|---|---|---|
| | Equivalent | incorporation | Mixing |
| Tradename/Name | weight | mass % | amount ratio |
| SucPHU2 | 1323 | 6.3 | 1.0 |
| Desmodur 2802 | 381 | N/A | 1.2 |

Carbon dioxide incorporation mass %: 4.4.

### 6.3.8. Formulation 8

Formulation 8 illustrates a topcoat formula in which ItPHU2 is first chain extended with hexamethylene diamine prior to curing with Desmodur 2802 (carbodiimide crosslinker). The ingredients are mixed with a ratio of 3.0:2.0:1.2.

In one embodiment, the mixing ratio may be within the range of 2.7-3.3:1.8-2.2:1.1-1.3. The carbon dioxide incorporation mass % may be within the range of 5.0-6.0%.

| | | Carbon dioxide | |
|---|---|---|---|
| | Equivalent | incorporation | Mixing |
| Tradename/Name | weight | mass % | amount ratio |
| ItPHU2 | 1334 | 6.3 | 3.0 |
| Hexamethylenediamine | 58 | N/A | 2.0 |
| Desmodur 2802 | 381 | N/A | 1.2 |

Carbon dioxide incorporation mass %: 5.5.

### 6.4. Example Flexible Substrate Construct

In Table 14, an exemplary carbon negative NIPU leather construction is presented. Using 100% knitted bamboo fabric as the backing fabric, with a typical synthetic leather construction thickness, 5.25% mass ratio carbon dioxide incorporation can be achieved, implying for every square meter, 34 grams carbon dioxide can be fixed.

TABLE 14
An exemplary construction with NIPU
topcoat on a bamboo fabric backing.

| Construction components | Description | Weight (g/m²) |
|---|---|---|
| Topcoat example 4 | Black-pigmented topcoat | 390 |
| Bamboo fabric | Knitted after viscose process | 260 |

### 7. EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the present disclosure.

All references, issued patents and patent applications cited within the body of the instant specification are hereby incorporated by reference in their entirety, for all purposes.

What is claimed is:

1. A bio-based non-isocyanate poly(hydroxyl urethane) (NIPU) coating for a flexible substrate comprising a combination of polymerized materials selected from:
(i) one or more biobased cyclic carbonate (CC) monomers; and
(ii) one or more biobased polyamines.

2. The coating of claim 1, further comprising one or more plant oils or one or more modified plant oils based or other biobased cyclic carbonate (CC) monomer formulated by carbon dioxide insertion into one or more epoxidized plant-based oils or one or more epoxidized modified plant-based oils or biobased glycidyl ether/ester type epoxies.

3. The coating of claim 2, wherein the epoxidized plant-based oils comprise epoxidized soybean oil or epoxidized linseed oil.

4. The coating of claim 2, wherein the epoxidized modified plant-based oils comprise epoxidized propylene glycol dioleate or epoxidized sucrose soyate.

5. The coating of claim 2, wherein the epoxidized modified plant-based oils comprise a first epoxidized oil with a first degree of functionality and a second epoxidized oil with a second degree of functionality higher than the first degree.

6. The coating of claim 2, wherein the epoxidized modified plant-based oils have an epoxy degree of functionality of 2.

7. The coating of claim 1, further comprising a first cyclic carbonate having a first degree of functionality and a second cyclic carbonate having a second degree of functionality higher than the first degree.

8. The coating of claim 1, wherein the biobased polyamines are synthesized by
1) reacting biobased diamine with biobased carboxylic acids; or
2) reacting biobased diamine with biobased carbonate.

9. The coating of claim 1, further comprising one or more biobased pigments or catalysts.

10. The coating of claim 1, further comprising one or more biobased solvents or additives.

11. The coating of claim 1, wherein the coating is formed by the process of:
dispersing bio-based NIPU prepolymers in water as a solvent to form a waterborne dispersion; and
curing the waterborne dispersion to form the coating.

12. The coating of claim 11, wherein the NIPU prepolymers are modified to have carboxylic acid end groups.

13. The coating of claim 12, wherein the process further comprises dispersing carbodiimide or epoxy crosslinkers in the waterborne dispersion.

14. The coating of claim 11, wherein the process further comprises chain extending amine-terminated NIPU prepolymers with one or more biobased acrylates or chain extending itaconate-terminated NIPU prepolymers with one or more biobased amines.

15. A flexible substrate construct including the coating of claim 1.

16. The flexible substrate construct of claim 15, wherein the leather alternative is bonded to a plant-based backing fabric on top of the coating thereby yielding a carbon negative bio-based leather alternative having specific mass ratio carbon dioxide incorporation.

17. The flexible substrate construct of claim 15, wherein the coating is applied as a textile coating or an animal leather top-finish.

18. A product including the coating of claim 1, the product comprising a textile, an animal leather, a wood product, a floor, a paper product, an architectural product, an aerospace product, an automotive product, or an industrial product.

19. A method of preparing a formulation comprising a bio-based non-isocyanate poly(hydroxyl urethane) (NIPU) coating for a flexible substrate comprising one or a combination of polymerized materials selected from:
(i) one or more biobased cyclic carbonate (CC) monomers; and
(ii) one or more biobased polyamines.

20. The method of claim 19, further comprising synthesizing one or more plant oils or one or more modified plant oils or biobased-glycidyl ethers/esters based cyclic carbonate (CC) monomers as the biobased cyclic carbonate (CC) monomers by carbon dioxide insertion into one or more epoxidized plant-based oils or one or more epoxidized modified plant-based oils.

21. The method of claim 20, wherein the epoxidized plant-based oils comprise epoxidized soybean oils or epoxidized linseed oils.

22. The method of claim 20, wherein the epoxidized modified plant-based oils comprise epoxidized propylene glycol dioleate or epoxidized sucrose soyate.

23. The method of claim 22, further comprising converting one or more epoxidized modified plant-based oils including a first oil to achieve cyclic carbonates with a first degree of functionality, and converting a second oil to achieve cyclic carbonates with a second degree of functionality higher than the first degree.

24. The method of claim 23, wherein the epoxidized modified plant-based oils have an epoxy degree of functionality of 2.

25. The method of claim 19, further comprising using first cyclic carbonates with a first degree of functionality and second cyclic carbonates with a second degree of functionality higher than the first degree.

26. The method of claim 19, further comprising synthesizing the biobased polyamines by 1) reacting biobased diamine with biobased carboxylic acids; and 2) reacting biobased diamine with biobased carbonate.

27. The method of claim 19, further comprising formulating the bio-based NIPU coating with biobased pigments or catalysts.

28. The method of claim 19, further comprising formulating the bio-based NIPU coating with biobased solvents or additives.

29. The method of claim 19, wherein the method further comprises:
dispersing bio-based NIPU prepolymers in water as a solvent to form a waterborne dispersion; and
curing the waterborne dispersion to form the coating.

30. The method of claim 29, wherein the NIPU prepolymers are modified to have carboxylic acid end groups.

31. The method of claim 30, wherein the method further comprises dispersing carbodiimide or epoxy crosslinkers in the waterborne dispersion.

32. The method of claim 31, wherein the method further comprises chain extending amine-terminated NIPU prepolymers with one or more biobased acrylates or chain extending itaconate-terminated NIPU prepolymers with one or more biobased amines.

33. The method of claim 19, further comprising constructing a leather alternative by bonding a plant-based backing fabric on top of an oven-cured biobased NIPU coating thereby yielding a carbon negative bio-based leather alternative having specific mass ratio carbon dioxide incorporation.

34. The method of claim 19, further comprising applying the coating in an application selected from a group consisting of: a textile coating and a flexible substrate coating.

35. The method of claim 19, further comprising applying the coating in an application selected from a group consisting of: a textile coating, an animal leather top-finish, a wood coating, a floor coating, a paper coating, an architectural coating, an aerospace coating, an automotive coating, and an industrial maintenance coating.

36. The method of claim 19, further comprising using a spray procedure to deposit the coating.

37. The method of claim 19, further comprising using one or more solvents or additives in the coating.
